(19) United States
(12) Patent Application Publication
(10) Pub. No.: US 2008/0028062 A1
(43) Pub. Date: Jan. 31, 2008

(54) DETERMINING MEASURES OF TRAFFIC ACCESSING NETWORK LOCATIONS

(75) Inventors: Brian E. Tschumper, Woodinville, WA (US); John A. Beaver, Kirkland, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 11/459,799

(22) Filed: Jul. 25, 2006

(51) Int. Cl. G06F 15/173

(52) U.S. Cl. 709/224; 709/223

(57) ABSTRACT

Systems, methods, and computer-readable media for determining measures of traffic accessing a network location are provided. Users may request traffic measures relevant to a target criteria. The target criteria may be parsed into intermediate target criteria. A server may be queried to determine if traffic measures relevant to the target criteria and/or any of the intermediate target criteria are stored in association therewith. If so, such traffic measures may be received. If not, such traffic measures may be determined. In embodiments, at least one traffic measure associated with an intermediate target criteria is utilized to determine the requested traffic measure.

### BACKGROUND

The World Wide Web is gaining popularity as an advertising platform. Many of today's commercial and personal web sites contain some form of advertising, e.g., banner ads, sidebar ads, floating ads, pop-up ads, pop-under ads, and the like. To be effective, a web advertisement needs to be viewed by those individuals the advertisement is intended to target. Accordingly, in making decisions regarding the network location(s) an advertiser desires to place its advertisement(s), knowledge about the viewing demographic for each potential network location is extremely helpful. Additionally, actual knowledge about the viewing demographic for a potential network location permits prospective viewing demographics to be estimated. Conventional methods for estimating prospective viewing demographics, however, are generally inefficient and require a large amount of processing power.

There are various models that can be utilized to estimate prospective viewing demographics, such as Bayesian models. Knowledge regarding various characteristics about the users accessing a network location can help advertisers predict which advertisements will be most successful if presented in association with that location. For example, if the viewers of a web site are predominately female and between the ages of 18-24, advertisements intended to target men in their fifties are unlikely to be successful if presented in association with that web site.

By determining causal relationships in network traffic, Bayesian models can be used to estimate a measure (e.g., quantity or percentage) of users accessing a network location who possess desired viewer characteristics. For example, desired viewer characteristics may include females, living in the United States, in the state of Washington, who are interested in purchasing a vehicle. To estimate the probability that users accessing a particular network location possess one or more of the desired viewer characteristics, conventional methods of estimating viewer demographics parse the desired viewer characteristic string into a plurality of intermediate criteria. Utilizing the above example, such intermediate criteria may include: (1) females, (2) females living in the United States, and (3) females living in the United States in the state of Washington. Using Bayesian models, the probability that a viewer accessing the network location satisfies any of the intermediate criteria is then determined. Subsequently, the probability that a viewer accessing the network location satisfies the entire desired viewer characteristic string is determined utilizing the intermediate criteria calculations. Conventional methods require determining a viewer demographic measure for each intermediate criteria before determining the viewer demographic measure for the entire desired viewer characteristic string. Determining such a measure for each intermediate criteria, however, requires a large amount of processing power, making the process expensive. While the above example is relatively simple, other targets may be more complex and include a myriad of intermediate criteria.

Another problem arising from the use of Bayesian models is that viewer demographic characteristic queries need to be answered in real time and not as a batch job. However, when there are numerous intermediate criteria making up a desired viewer demographic characteristic string, determining a viewer demographic measure for each intermediate criteria requires a substantial amount of time and can be very inefficient. Consequently, conventional methods of estimating prospective network traffic with Bayesian models cannot efficiently handle all intermediate criteria in real time.

It should be noted that the aforementioned problems are not unique to web environments. Any public or private network utilizing Bayesian models to estimate prospective network traffic may also experience the above difficulties. For example a peer-to-peer network, internal corporate database, or the like may be subject to the same difficulties.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention provide systems, methods, and computer-readable media for determining measures of traffic accessing a network location, the traffic satisfying a target criteria. Embodiments include parsing the target criteria into a plurality of intermediate target criteria, determining a measure of traffic accessing the network location that satisfies each of the intermediate target criteria, and caching the determined measures of traffic for the intermediate target criteria. The cached traffic measures for the intermediate target criteria may subsequently be utilized to satisfy future requests that include the same intermediate target criteria without having to spend the processing resources to re-determine the traffic measures. Embodiments also include communicating cached traffic measures among networked servers. Utilizing the systems, methods, and computer-readable media described herein, one can readily determine characteristics about the viewers accessing a network location and estimate prospective network traffic. In embodiments, such characteristics may be used by owners of advertising space to market the space to advertisers, by advertisers to determine a price they are willing to pay to advertise at a particular network location, and/or by administrators to audit the characteristics of viewers of material presented in conjunction with a given network location.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing device for use in implementing an embodiment of the present invention;

FIG. 2 is a block diagram of a networking architecture for use in implementing an embodiment of the present invention;

FIG. 3 is a flow diagram illustrating a method for determining a measure of traffic accessing a network location, the traffic satisfying a target criteria, according to an embodiment of the present invention; and

FIG. 4 is a flow diagram illustrating a method, in accordance with an embodiment of the present invention, for determining a measure of traffic accessing a network location, the traffic satisfying a target criteria.

### DETAILED DESCRIPTION

The subject matter described herein is presented with specificity to meet statutory requirements. The description herein is not intended, however, to limit the scope of this patent. Rather, it is contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide systems, methods, and computer-readable media for determining measures of traffic accessing a network location, the traffic satisfying a target criteria. Embodiments include parsing the target criteria into a plurality of intermediate target criteria, determining a measure of traffic accessing the network location that satisfies each of the intermediate target criteria, and caching the determined measures of traffic for the intermediate target criteria. The cached traffic measures for the intermediate target criteria may subsequently be utilized to satisfy future requests that include the same intermediate target criteria without having to spend the processing resources to re-determine the traffic measures. Embodiments also include communicating cached traffic measures among networked servers. Utilizing the systems, methods, and computer-readable media described herein, one can readily determine characteristics about the viewers accessing a network location and estimate prospective network traffic. In embodiments, such characteristics may be used by owners of advertising space to market the space to advertisers, by advertisers to determine a price they are willing to pay to advertise at a particular network location, and/or by administrators to audit the characteristics of viewers of material presented in conjunction with a given network location.

“Network traffic,” as the term is utilized herein, may be any type of user-interaction with a network location (e.g., a web site, internal database, etc.) over a communications network. Communications networks include, without limitation, the Internet, virtual private networks, Intranets, Local Area Networks (“LANs”), Wide Area Networks (“WANs”), Metropolitan Area Networks (“MANs”), wireless networks, and the like. Furthermore, it will be understood by one of ordinary skill in the art that embodiments are not limited to network traffic and the methods taught herein may be used to predict various other patterns of data. Examples of such data include, without limitation, characteristics of the people ordering a product, the characteristics of users working offline, or other data logs.

As the term is utilized herein, “target criteria” refers to any characteristic or combination of characteristics desired in a viewing demographic. Examples of such characteristics include, without limitation, age, gender, race, ethnicity, geographic location, time, hobbies, interests, patterns, and the like. Target criteria may also include actions viewers have previously performed or that their behavior indicates they are contemplating performing, such as, inquiring about vehicle price and/or performance, selecting particular displayed advertisements to find out additional information about the advertised product or service, watching movies of a particular genre, etc. One exemplary target criteria, which will be referenced throughout the present description, is females, living in the United States, in the state of Washington, who are contemplating purchasing a vehicle. It will be understood and appreciated by those of ordinary skill in the art that the referenced example is merely illustrative and not restrictive and that embodiments of the present invention are not limited to any particular target criteria or combination thereof.

“Intermediate target criteria,” as the term is utilized herein, is one or more characteristics that make up a portion of the target criteria but that includes fewer than all of the target criteria characteristics. Thus, referring back to the above example, the target criteria includes three intermediate target criteria: (1) females, (2) females living in the United States, and (3) females living in the United States and in the state of Washington.

As previously stated, using models, e.g., Bayesian models, to determine measures of network traffic satisfying a target criteria may be time consuming and hardware intensive. Embodiments of the present invention aid in reducing time and processing expense by caching traffic measures satisfying the intermediate target criteria so that such measures may be retrieved at a later time without having to be re-determined. Additionally, embodiments are directed to communicating traffic measures satisfying intermediate target criteria among networked servers so that any networked server receiving a request for viewer demographics may have access to such pre-determined information.

Having briefly described a general overview of the embodiments described herein, an exemplary operating environment is described below.

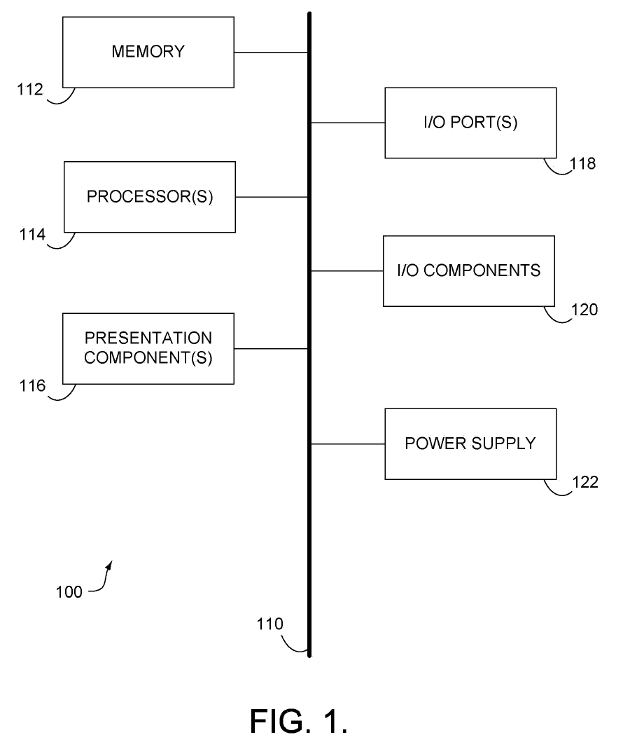

Referring initially to FIG. 1 in particular, an exemplary operating environment for implementing the present invention is shown and designated generally as computing device 100. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In one embodiment, computing device 100 is a personal computer. But in other embodiments, computing device 100 may be a cell phone, digital phone, handheld device, personal digital assistant (“PDA”), or other device capable of executing computer instructions.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, and the like, refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

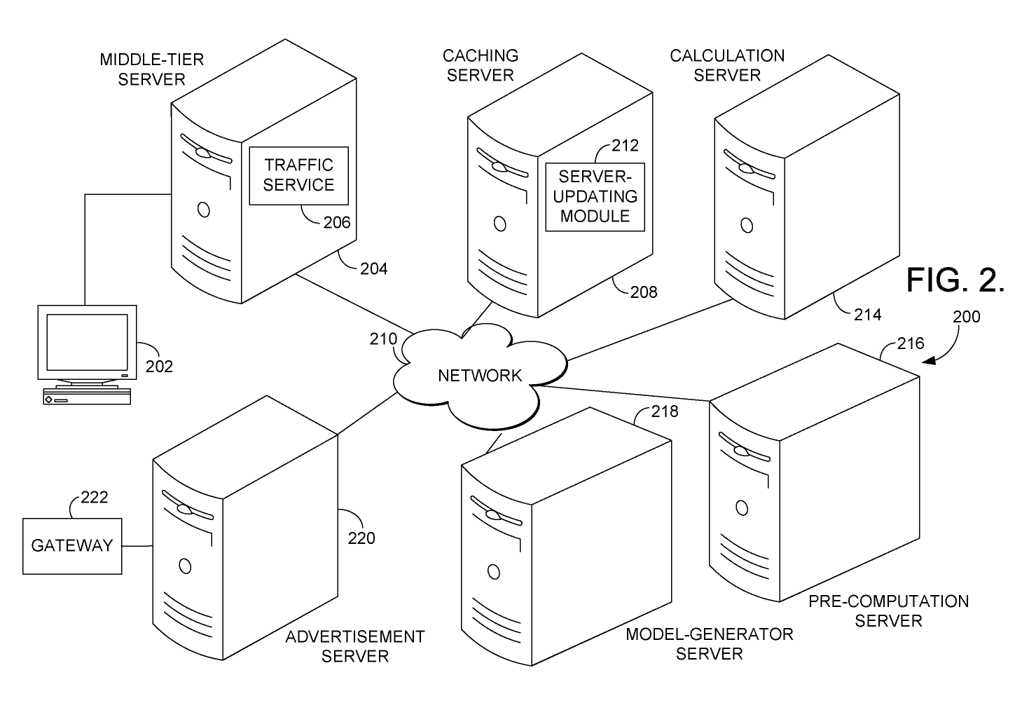

Turning now to FIG. 2, a block diagram of a network architecture for use in implementing an embodiment of the present invention is illustrated and designated generally as reference numeral 200. Network architecture 200 includes a client computing device 202, a middle-tier server 204, a caching server 208, a calculation server 214, a pre-computation server 216, a model-generator server 218, an advertisement server 220, and a gateway 222, all in communication with one another through a network 210. It will be understood and appreciated by one of ordinary skill in the art that the network architecture 200 shown in FIG. 2 is merely an example of one suitable networking environment and is not intended to suggest any limitation as to the scope of use or functionality of embodiments of the present invention. Neither should network architecture 200 be interpreted as having any dependency or requirement related to any single component or combination of components illustrated therein.

The client computing device 202 may be any type of computing device, e.g., device 100 described above with reference to FIG. 1. By way of example only and not limitation, the client computing device 202 may be a personal computer, desktop computer, laptop computer, handheld device, cellular phone, digital phone, PDA, or the like. It should be noted, however, that embodiments of the present invention are not limited to implementation on such computing devices, but may be implemented on any of a variety of different types of computing devices within the scope hereof.

Network 210 may include any computer network or combination of computer networks. Examples of computer networks configurable to operate as network 210 include, without limitation, a wireless network, landline, cable line, fiber-optic line, LAN, WAN, MAN or the like. Network 210 is not limited, however, to connections coupling separate computer units. Rather, network 210 may also comprise subsystems that transfer data between servers or computing devices. For example, network 210 may also include a point-to-point connection, an internal system Ethernet, a backplane bus, an electrical bus, a neural network, or other internal system. In an embodiment where network 210 comprises a LAN networking environment, components are connected to the LAN through a network interface or adapter. In an embodiment where network 210 comprises a WAN networking environment, components may use a modem, or other means for establishing communications over the WAN, to communicate. In embodiments where network 210 comprises a MAN networking environment, components are connected to the MAN using wireless interfaces or optical fiber connections. Such networking environments are commonplace in offices, enterprise-wide computer networks, intranets, and the Internet. It will be understood and appreciated that the network connections shown are exemplary and other means of establishing a communications link between the computing devices may also be used within embodiments of the present invention.

Though not shown for the sake of clarity, components of each server, (i.e., middle-tier server 204, caching server 208, calculation server 214, pre-computation server 216, model-generator server 218, aggregating server, and advertisement server 220) may include, without limitation, a processing unit, internal system memory, and a suitable system bus for coupling various system components, including one or more databases for storing information (e.g., files and metadata associated therewith). Each server typically includes, or has access to, a variety of computer-readable media. By way of example, and not limitation, computer-readable media may include computer-storage media and communication media. In general, communication media enables each server to exchange data via network 210. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

It will be understood by those of ordinary skill in the art that networking architecture 200 shown in FIG. 2 is merely exemplary. While each server is illustrated as a single unit, one skilled in the art will appreciate that each server is scalable. For example, caching server 208 and/or calculation server 214 may be any number of servers in communication with one another (e.g., via network 210) The single unit depictions are meant for clarity and not to limit the scope of embodiments of the present invention in any way.

Each of the illustrated servers shown in FIG. 2 may be any type of application server, database server, or file server configurable to perform one or more of the methods described herein. In addition, each server may be a dedicated or shared server. One example, without limitation, of a server that is configurable to operate as the middle-tier server 204, the caching server 208, the calculation server 214, the pre-computation server 216, model-generator server 218, and/or the advertisement server 220 is a structured query language (“SQL”) server executing server software such as SQL Server 2005, which was developed by the Microsoft® Corporation headquartered in Redmond, Wash.

The client computing device 202 is accessible by a user. The user may be an administrator, advertiser, advertising space owner, or any other individual seeking information related to viewer characteristics. In one embodiment, a user may utilize client computing device 202 to submit a request for a measure of traffic accessing a particular network location, the traffic satisfying a specified target criteria. For instance, referring back to the above example, a user may submit a request for a measure of traffic accessing a particular web page who are female, living in the United States, living in the state of Washington, and who are searching for a vehicle. In one embodiment, the user may submit the request through a software application executing on the client computing device 202 via a graphical user interface. However, any of a variety of request submission methods known to those of ordinary skill in the art may be utilized within the scope of embodiments hereof.

In operation, once a traffic measure request has been received by the client computing device 202, the client computing device 202 communicates the request to the middle-tier server 204. Any type of public or private network (such as those mentioned herein) may enable communication between the middle-tier server 204 and the client computing device 202. In one embodiment, the middle-tier server 204 executes a traffic service 206. In an alternative embodiment (not shown in FIG. 2 for clarity), the traffic service 206 executes on the client computing device 202. In one embodiment, the traffic service 206 is a web service configured to support interoperable machine-to-machine communication between the client computing device 202 and the middle-tier server 204. In another embodiment, the traffic service 206 includes an application programming interface (“API”) configurable to access caching server 208. Examples of such APIs include, without limitation, active data objects (“ADO”), remote data objects (“RDO”), and the like.

The traffic service 206 is additionally configured to parse the target criteria into intermediate target criteria and communicate requests for traffic measures related to the target criteria and each of the intermediate target criteria to the caching server 208. The target criteria may be parsed using a number of methods known to those of ordinary skill in the art. In one embodiment, each characteristic comprising the target criteria and/or one or more of the intermediate target criteria is compared to a list of characteristic strings stored on the middle-tier server 204 to determine whether it designates a known string. If it is determined to be a known string, a tag is associated therewith. For instance, in the above-described example, the characteristic “female” may be stored and tagged as a gender, the characteristic “United States” may be stored and tagged as a country, and the characteristic “Washington” may be stored and tagged as a state. Consequently, the intermediate target criteria that includes females living in the United States in the state of Washington would be assigned tags for gender, country and state. Additionally, to indicate which gender, country, and/or state is included in the intermediate target criteria, values may be assigned along with the tags to designate the specific characteristics.

For example, female may include a hexadecimal tag designating gender of 000F and a value designating the type of gender (female) of 000A. Such would result in the intermediate target criteria being assigned the hexadecimal designation of 000F 000A. In this embodiment, target criteria and/or intermediate target criteria are effectively represented by digital numbers. Embodiments are not limited, however, to any particular method of parsing or tagging as those of ordinary skill in the art will appreciate that numerous methods exist that permit such functionality.

In one embodiment, the middle-tier server 204 is configured to communicate the tagged intermediate target criteria and/or the tagged target criteria to the caching server 208. The caching server 208 is configured to store various measures of traffic associated with target criteria (and intermediate target criteria) related to a plurality of network locations. For example, caching server 208 may contain the number of males and the number of females accessing a particular network location within a given time frame. The traffic measures may represent the number of users with a specific criteria who access the network locations, a percentage thereof, or any other quantitative indication of traffic. In other embodiments, traffic measures include estimations of prospective traffic accessing the location. For example, the caching server 208 may include a prospective estimation that 75% of the traffic to access the network location during the next five days will be female and that 65% will be females living in the United States, in the state of Washington. It will be understood and appreciated, however, that embodiments of the present invention are not limited to any particular traffic measures, as numerous expressions of network traffic are possible.

The caching server 208 is additionally configured to determine whether a requested measure of traffic relevant to the target criteria has already been stored therein. If it is determined that a measure of traffic has already been stored in the caching server 208, the requested traffic measure is communicated to the middle tier server 204 and the user's request is satisfied. If, however, it is determined that the requested measure of traffic relevant to the target criteria has not already been stored in association with the caching server 208, the caching server 208 determines whether traffic measures for any of the intermediate target criteria have been stored in association therewith. If it is determined that a traffic measure for one or more of the intermediate target criteria has already been stored in association with the caching server 208, a request for a traffic measure for the intermediate criteria for which a traffic measure is unknown and the target criteria is communicated to the calculation server 214. Additionally communicated to the calculation server 214 are the traffic measures relevant to any intermediate criteria for which a traffic measure is stored in association with the caching server.

To more accurately predict network traffic, it may be advantageous to tag traffic measures stored on the caching server 208 as a particular version. In other words, the caching server 208 may tag stored criteria (such as females in Washington) with multiple version values. In one embodiment, the particular version is a reference to a specific time frame. For example, the caching server 208 may store the number of females from Washington that visited a particular network location over the course of multiple time frames. With such data, the number of women viewing the network location over time can be determined. It will be apparent to one of ordinary skill in the art that other version tags are also possible.

The calculation server 214 is configured to determine the traffic measures relevant to those requests which it receives from the caching server 208. If the calculation server 214 has received any traffic measures relevant to one or more of the intermediate target criteria comprising the target criteria, the calculation server 214 may utilize such information to determine the requested traffic measures. In this way, the calculation server 214 may save time and processing expense in its determinations. Once the requested traffic measures are determined, they are communicated back to the caching server 208 and stored in association therewith. By storing traffic measures in association with the target criteria or intermediate target criteria to which they pertain on the caching server 208, less time and processing power is required to satisfy future traffic measure requests that have one or more intermediate target criteria in common.

The caching server 208 may include a communication or server-updating module 212. Because the caching server 208 may include a plurality of interconnected servers, quantities that are stored on one caching server may not be stored on another caching server. In an embodiment, the communication module 212 is a software application, web service, routine, sub-routine, or other set of machine-executable instructions. In operation, the communication module 212 communicates stored traffic measures to all networked caching servers. Methods of communicating such information are well known to those skilled in the art and may include, for example, push methods, pull methods, push-pull methods, and the like.

In one embodiment, the caching server 208 is configured to receive traffic measures relevant to target criteria and/or intermediate target criteria from the calculation server 214, the pre-computation server 216, or any other server via the communication module 212. In one embodiment, the calculation server 214 is configured to determine traffic measures relevant to the target criteria and any intermediate target criteria that are not stored in association with the caching server 208. To determine these unknown traffic measures, the calculation server 214 applies statistical models well known to those skilled in the art, such as, for example, a Bayesian model generated by the model-generator server 218 (discussed more fully below). In one embodiment, the resultant traffic measures are communicated to the caching server 208 for storage in association therewith.

Increasing the quantity of traffic measures stored on the caching server 208 increases the probability that a target or intermediate criteria can be satisfied without accessing the calculation server 214. Eliminating the calculation server 214 saves valuable time and increases the speed that the traffic measure request is answered. Therefore, all traffic measures calculated by the calculation server 214 are stored on the caching server 208. Additionally, the caching server 208 may poll the pre-computation server 216 for computed traffic measures that have been generated by the model generator 218.

The model generator 218 is configured to periodically receive logs of network activity for a plurality of network locations from an aggregating server (not shown for clarity) that periodically samples the network locations on a background thread and stores sampled traffic measures. Once a new log is received by the model-generator server 218, the model-generator server 218 is configured to generate one or more traffic measures using statistical models to estimate prospective network traffic. Any statistical model (e.g., a Bayesian model) well known to those of skill in the art may be used by the model-generator 218 to generate the traffic measure. Computed traffic measures are transmitted to the pre-computation server 216, which transmits the traffic measures to the caching server 208.

Sampled traffic measures may include the quantity of traffic associated with any characteristic or combination of characteristics (e.g., females under the age of thirty who access a particular network location during the relevant time frame). Numerous methods for tracking network activity are well known to those skilled in the art and need not be discussed at length herein. In embodiments, the logs may include a quantity of users accessing the network locations as well as a probability with which particular characteristics (or combinations thereof) are associated with those users. In one embodiment, each log of information is time stamped so that it can be eliminated from the pre-computation server 216 when the log becomes stale or a newer version thereof is received.

It may be inefficient to predict prospective traffic measures for every log generated by the aggregating server. Therefore, the aggregating server may be configured to only transmit logs of network activity to the model-generator 218 relating to the most popular characteristics of the network traffic. For example, the aggregating server may determine that sixty percent of the visitors to a network location are female. Consequently, the aggregating server may not create or transmit a log to the model-generator server 218 for males. In another example, suppose a web page is viewed ten thousand times—six thousand times by females with children, two thousand times by males over forty, one thousand times by teenage females, and one thousand times by divorced males. In this scenario, the aggregating server may transmit a log that only represents the females with children. Alternatively, the log may also include the traffic measure representing the males over forty. In either situation, the logs are restricted to a frequently occurring characteristic, thus reducing the volume of information needing to be calculated by the model-generator server 218. Furthermore, network traffic logs may be periodically generated (i.e., daily, weekly, etc.) and automatically pushed to the model-generator 218.

In one embodiment, the logs from the aggregating server or the computed traffic measures from the model-generator 218 may be modified according to pre-defined threshold criteria set by an administrator. Alternatively, the threshold criteria may be set by the frequency with which a traffic measure has been requested for a particular target criteria or intermediate target criteria. In still another embodiment, the threshold criteria may be determined from the recorded network activity on the aggregating server.

In one embodiment, the statistical models are communicated to the calculation server 214. The calculation server 214 uses the models to determine traffic measures for target and intermediate target criteria.

In addition to the logs, the model-generator server 218 may also use parameters supplied by the advertisement server 220 to generate the statistical models. The advertisement server 220 is a server that stores various parameters relevant to advertisements or other administrative needs. For example, the advertisement server 220 may store rates for advertising at particular network locations, sampling rates of network locations, or the like.

In one embodiment, parameters are supplied to the advertisement server 220 via a gateway 222. The gateway 222 may include a web site, web service, or other user-interactive application through which web advertisements are requested.

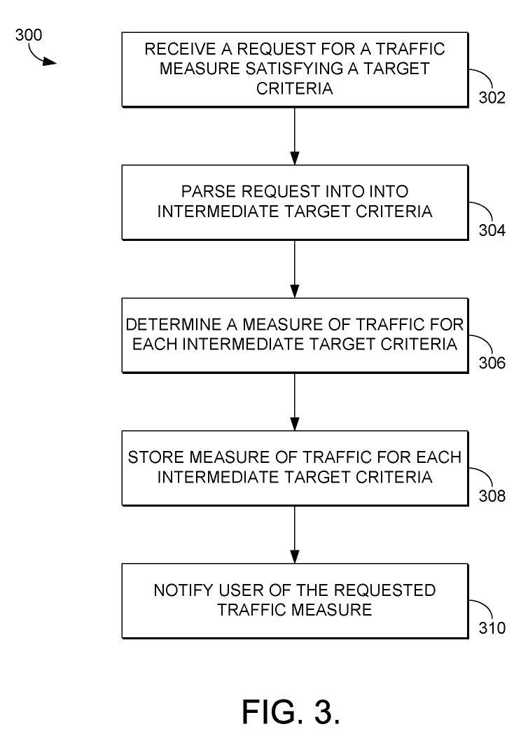

Turning now to FIG. 3, a flow diagram is illustrated showing a method 300 in accordance with an embodiment of the present invention for determining one or more measures of traffic accessing a network location, the traffic satisfying a target criteria. Initially a request for the measure of traffic is received, as indicated at 302. The request may be submitted by a user to a server, such as a middle-tier server 204 (FIG. 2). Subsequently, as indicated at 304, the request is parsed into a plurality of intermediate target criteria. Parsing can occur using any of the aforementioned methods or methods known to those of ordinary skill in the art. Next, a measure of traffic associated with each of the plurality of intermediate target criteria is determined, as indicated at 306. Once determined, the measure of traffic associated with each of the plurality of intermediate target criteria is stored in a cache, as indicated at 308. If desired, the user may subsequently be notified of the requested traffic measure, as indicated at 310, for instance, via presentation thereof on a graphical user interface.

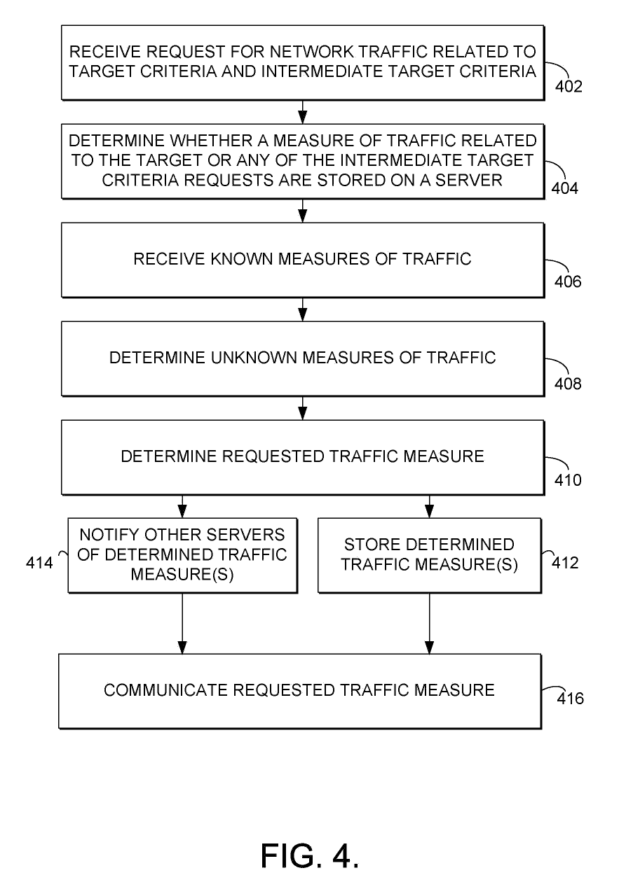

With reference to FIG. 4, a flow diagram is illustrated showing a method 400 in accordance with an embodiment of the present invention for determining one or more measures of traffic accessing a network location, the traffic satisfying a target criteria. Initially, a request is received for at least one measure of traffic that satisfies a target criteria accessing a network location, the target criteria including a plurality of intermediate target criteria, as indicated at 402. In one embodiment, the request is communicated to the caching server 208 from the middle-tier server 204. Subsequently, as indicated at 404, it is determined if a measure of traffic that satisfies each of the plurality of intermediate target criteria is stored on a server. If it is determined that a measure of traffic that satisfies each of the plurality of intermediate target criteria is stored on a server, the measure(s) of traffic satisfying such criteria is received. This is indicated at 406. If it is determined that a measure of traffic that satisfies at least one of the plurality of intermediate target criteria is not stored on a server, the measure(s) of traffic that are unknown are determined, as indicated at 408. Utilizing the received measure of traffic that satisfies the at least one of the plurality of intermediate target criteria that is stored on a server and the determined measure of traffic that satisfies the at least one of the plurality of intermediate target criteria that is not stored on the server, the measure of traffic accessing the network location that satisfies the target criteria is determined, as indicated at 410. If desired, as indicated at 412, the determined measure(s) of traffic may subsequently be stored in association with at least one server. Additionally, if desired, such stored measure(s) of traffic may be communicated among networked servers. This is indicated at 414. The network-traffic information relevant to the target request is then returned to the middle-tier, as indicated at 416.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-readable media having computer-useable instructions embodied thereon for determining one or more measures of traffic accessing a network location, the traffic satisfying a target criteria, the computer-readable media comprising:
a traffic service configured to receive a request for the one or more measures of traffic accessing the network location, the traffic satisfying the target criteria, and to parse the request into a plurality of intermediate target criteria;
a caching server configured to store one or more actual traffic measures related to a plurality of network locations and to retrieve at least one actual measure of traffic that satisfies at least one of the target criteria and any of the plurality of intermediate target criteria for which the at least one actual measure of traffic is stored in association with the caching server; and
a calculation server configured to determine at least one actual measure of traffic that satisfies any intermediate target criteria for which there is not an actual measure of traffic stored in association with the caching server and to communicate the at least one determined actual measure of traffic to the caching server.

2. The computer-readable media of claim 1, further comprising a model generator server configured to receive one or more logs which include an actual measure of traffic for one or more of the plurality of network locations and to generate prospective measures of traffic utilizing the one or more logs.

3. The computer-readable media of claim 2, wherein the model generator is further configured to compare the at least one actual measure of traffic for each of the plurality of network locations from the one or more logs with a threshold traffic measure to determine, for each of the plurality of network locations, whether to generate at least one prospective measure of traffic.

4. The computer-readable media of claim 1, wherein the one or more actual traffic measures comprise one of a quantity of traffic and a percentage of total traffic accessing at least one of the plurality of network locations.

5. The computer-readable media of claim 1, wherein the caching server includes a communication module configured to communicate the at least one determined actual measure of traffic to one or more servers that are in communication with the caching server.

6. The computer-readable media of claim 1, wherein the communication module is further configured to communicate to the calculation server any actual measure of traffic that satisfies any of the intermediate target criteria for which the actual measure of traffic is stored in association with the caching server.

7. The computer-readable media of claim 6, wherein the calculation server is further configured to receive, from the communication module of the caching server, any actual measure of traffic that satisfies any of the intermediate target criteria for which the actual measure of traffic is stored in association with the caching server and to utilize any received actual measure of traffic to determine one or more measures of traffic accessing the network location, the traffic satisfying the target criteria.

8. One or more computer-readable media having computer-useable instructions embodied thereon for performing a method for determining a measure of traffic accessing a network location, the traffic satisfying a target criteria, the method comprising:
receiving a request for the measure of traffic accessing the network location, the traffic satisfying the target criteria;
parsing the received request into a plurality of intermediate target criteria;
determining a measure of traffic associated with each of the plurality of intermediate target criteria; and
storing the measure of traffic associated with each of the plurality of intermediate target criteria in a cache.

9. The computer-readable media of claim 8, further comprising utilizing the measure of traffic associated with each of the plurality of intermediate target criteria to determine the measure of traffic accessing the network location that satisfies the target criteria.

10. The computer-readable media of claim 8, wherein determining a measure of traffic associated with each of the plurality of intermediate target criteria comprises determining if one or more of the plurality of intermediate target criteria is stored in a cache, wherein each intermediate target criteria that is stored in a cache has a measure of traffic associated therewith.

11. The computer-readable media of claim 10, wherein if it is determined that one or more of the plurality of intermediate target criteria is stored in a cache, storing the measure of traffic associated with each of the plurality of intermediate target criteria comprises storing the measure of traffic associated with each of the plurality of intermediate target criteria that is determined to not be stored in a cache.

12. The computer-readable media of claim 10, further comprising utilizing the measure of traffic associated with the at least one of the plurality of intermediate target criteria that is stored in a cache to determine the measure of traffic accessing the network location that satisfies the target criteria.

13. The computer-readable media of claim 8, wherein the measure of traffic accessing the network location and the measure of traffic associated with each of the plurality of intermediate target criteria comprise one of a quantity of traffic and a percentage of total traffic.

14. The computer-readable media of claim 8, further comprising presenting the measure of traffic accessing the network location.

15. The computer-readable media of claim 8, further comprising:
receiving one or more logs which include at least one actual measure of traffic for each of the plurality of network locations; and
generating prospective measures of traffic utilizing the one or more logs.

16. A computer-implemented method for determining measures of traffic accessing a network location, the traffic satisfying a target criteria, the method comprising:
receiving a request for at least one measure of traffic that satisfies a target criteria accessing a network location, the target criteria including a plurality of intermediate target criteria;
determining if a measure of traffic that satisfies each of the plurality of intermediate target criteria is stored on a server;
if it is determined that a measure of traffic that satisfies at least one of the plurality of intermediate target criteria is stored on a server, receiving the measure of traffic that satisfies the at least one of the plurality of intermediate target criteria that is stored on the server;
if it is determined that a measure of traffic that satisfies at least one of the plurality of intermediate target criteria is not stored on a server determining the measure of traffic that satisfies the at least one of the plurality of intermediate target criteria that is not stored on a server; and
utilizing the received measure of traffic that satisfies the at least one of the plurality of intermediate target criteria that is stored on the server and the determined measure of traffic that satisfies the at least one of the plurality of intermediate target criteria that is not stored on a server to determine the measure of traffic accessing the network location that satisfies the target criteria.

17. The method of claim 16, further comprising storing the determined measure of traffic that satisfies the at least one of the plurality of intermediate target criteria on a server.

18. The method of claim 16, further comprising communicating at least one of the determined measure of traffic that satisfies the at least one of the plurality of intermediate target criteria and the measure of traffic accessing the network location that satisfies the target criteria to one or more servers.

19. The method of claim 16, further comprising:
determining if at least one of the determined measure of traffic that satisfies at least one of the plurality of intermediate target criteria and the measure of traffic that satisfies the target criteria meets a threshold measure; and
if it is determined that at least one of the determined measure of traffic that satisfies at least one of the plurality of intermediate target criteria and the measure of traffic that satisfies the target criteria meets a threshold measure, generating a prospective measure of traffic that satisfies the at least one of the plurality of intermediate target criteria and the target criteria.

20. One or more computer-readable media having computer-useable instructions embodied thereon for performing the method of claim 16.
